(19) United States
(12) Patent Application Publication
(10) Pub. No.: US 2005/0157914 A1
(43) Pub. Date: Jul. 21, 2005

(54) TFT sensor having improved imaging surface

(76) Inventors: Jee-Hoon Kim, Cupertino, CA (US); Akiba Shigetaka, Setagaya-ku (JP); Dong-Won Lee, Saratoga, CA (US)

Correspondence Address: SecuGen Corporation, 2356 WALSH AVENUE, SANTA CLARA, CA, 95051, US

(21) Appl. No.: 10/646,655

(22) Filed: Aug. 21, 2003

Related U.S. Application Data
(60) Provisional application No. 60/405,604, filed on Aug. 21, 2002.

(51) Int. Cl. G02F 1/1333

(52) U.S. Cl. 382/127

(57) ABSTRACT

Disclosed is an image capture sensor including a light detection transistor having a light sensitive layer which conducts electricity in response to detection of a predetermined amount of light and a switch interconnected to the light detection transistor and responsive to detection of light by the light detection transistor. A glass substrate is layered over both the light detection transistor and switch. The glass substrate provides a durable and smooth surface upon which a patterned object to be imaged in placed.

### CROSS-REFERENCE TO RELATED APPLICATIONS

This application claims priority to provisional patent application Ser. No. 60/405,604 filed Aug. 21, 2002.

### BACKGROUND OF THE INVENTION

1. Field of the Invention

The present invention relates generally to a imaging of a patterned object such as a fingerprint. More specifically, this invention relates to patterned object capture sensors including thin-film transistors.

2. Background

As known to those skilled in the art, fingerprint recognition is a kind of technology for granting an access authorization to systems such as a computer, an access control system, a banking system, etc. Fingerprint recognition systems are generally classified into two types: optic type system using a lens and a prism, and non-optic type system using a semiconductor or thin-film transistor (TFT), not a lens. A TFT fingerprint capture device is a kind of contact image sensor using photosensitivity of a-Si:H, and has high photosensitivity due to its relatively thin structure.

The structure of the fingerprint capture sensor is shown in FIG. 1. FIG. 1 is a vertical sectional view showing a unit cell of a conventional fingerprint capture sensor. FIG. 1 illustrates a conventional thin film transistor (TFT) image acquisition sensor which may be used to image a fingerprint for use with equipment and software providing identity verification. Such an image acquisition device is disclosed in co-pending U.S. patent application Ser. No. 10/014,290 filed Dec. 10, 2001, which is hereby incorporated by reference in its entirety. FIG. 1 is a sectional view showing a unit cell of a conventional fingerprint capture sensor. In the fingerprint capture sensor 10 a light sensing unit 12 and a switching unit 13 are horizontally arranged on a transparent substrate 11. Under the transparent substrate 11, a back light (not shown) irradiates light upward to be passed through the fingerprint capture sensor 10. A source electrode 12-S of the light sensing unit 12 and a drain electrode 13-D of the switching unit 13 are electrically connected to each other through a first electrode 14. A gate electrode 12-G of the light sensing unit 12 is connected to a second electrode 15.

In the above structure, a photosensitive layer 12-P such as amorphous silicon (a-Si:H) is formed between the drain electrode 12-D and source electrode 12-S of the light sensing unit 12. Then, when more than a predetermined quantity of light is received, current flows through the drain electrode 12-D and the source electrode 12-S. FIG. 2 illustrates how sensor 10 operates to capture a ridge 22 of a fingerprint 20. Light 24 generated from the back light under the transparent substrate 11 is reflected on a fingerprint pattern and received by the photosensitive layer 12-P of the light sensing unit 12, thus causing electricity to flow in the light sensing unit 12. Referring again to FIG. 1, an upper surface ranging from the drain electrode 13-D to the source electrode 13-S is covered with a light shielding layer 13-sh such that external light cannot be received by the switching unit 13. Preferably, an insulating layer 17 is formed over first electrode 14 and a passivation layer 18 is formed over insulating layer 17. Passivation layer 18 can be formed of silicon-nitride (SiNx) and is provided to electrically and physically protect the remainder of capture sensor 10. As is understood by those skilled in the art, an array of capture sensors such as capture sensor 10 can be formed to image an entire fingerprint.

Regarding capture sensor 10, however, passivation layer 18 may not be durable enough to withstand many repeated uses of sensor 10. Additionally, it may be difficult to make the surface of passivation layer 18 relatively smooth. And, irregularities in the surface of passivation layer 18 can distort a fingerprint image which sensor 10 is acquiring.

### BRIEF SUMMARY OF THE INVENTION

An image capture sensor in accordance with the present invention includes a glass layer on which an object to be imaged is placed. Unlike the passivation layer discussed above in the background section, a glass layer can be made thick enough to be relatively durable and is relatively smoother than the passivation layer of the prior art. Accordingly, an image capture sensor in accordance with the present invention includes a light detection transistor having a light sensitive layer which conducts electricity in response to detection of a predetermined amount of light and a switch interconnected to the light detection transistor and responsive to detection of light by the light detection transistor. A glass substrate is layered over both the light detection transistor and switch. The glass substrate is the surface upon which a patterned object to be imaged in placed.

In another aspect of the invention, the glass substrate include fiber-optic strands, allowing the glass substrate to be thicker and, thereby, advantageously more durable.

### BRIEF DESCRIPTION OF THE DRAWINGS

FIG. 1 is a sectional view of a prior art thin-film transistor object capture sensor which includes a light sensing transistor and a switch and which can be used to detect a patterned object such as a fingerprint.

FIG. 2 is an illustration showing the operation of the object capture sensor shown in FIG. 1.

FIG. 3 is a sectional view of an object capture sensor including a glass substrate on which an object to be patterned is to be placed in accordance with the present invention.

FIG. 4a is an illustration of the operation of the object capture sensor shown in

FIG. 4b is an illustration showing detail of the operation of the object capture sensor shown in FIGS. 3 and 4a.

FIG. 5 is a sectional view of a second embodiment of an object capture sensor including a conducting layer adjacent to a glass substrate on which an object to be patterned is to be placed in accordance with the present invention.

FIG. 6 is a sectional view of a third embodiment of an object capture sensor—including fiber-optic strands in a glass substrate on which an object to be patterned is to be placed in accordance with the present invention.

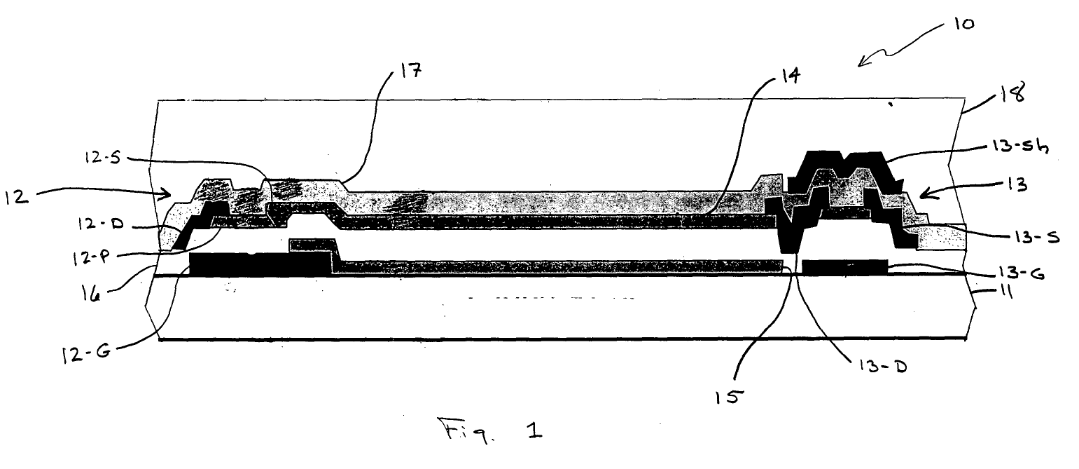

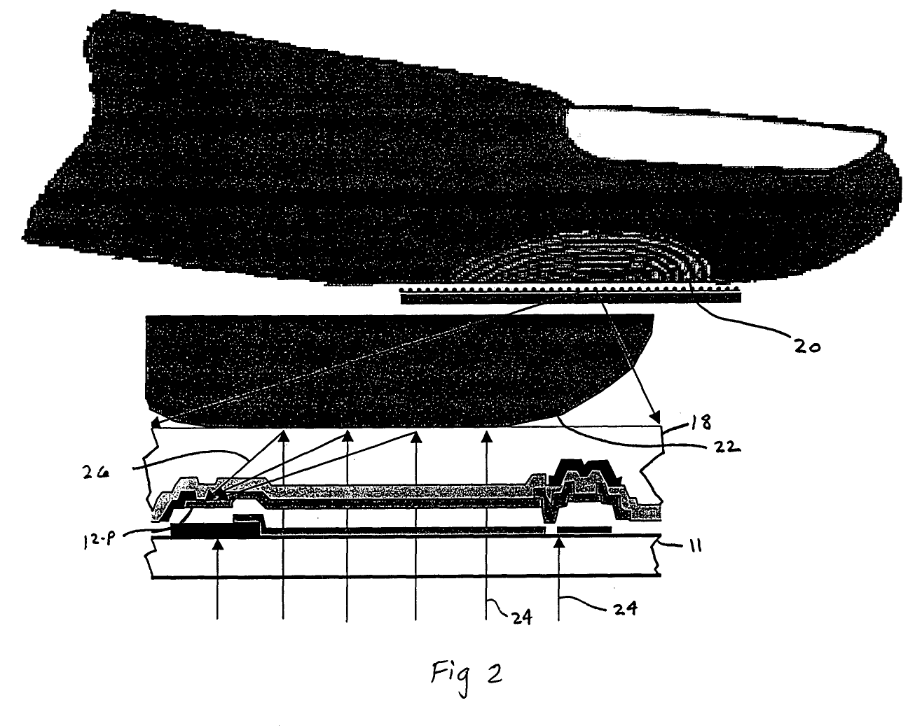

### DETAILED DESCRIPTION OF THE INVENTION

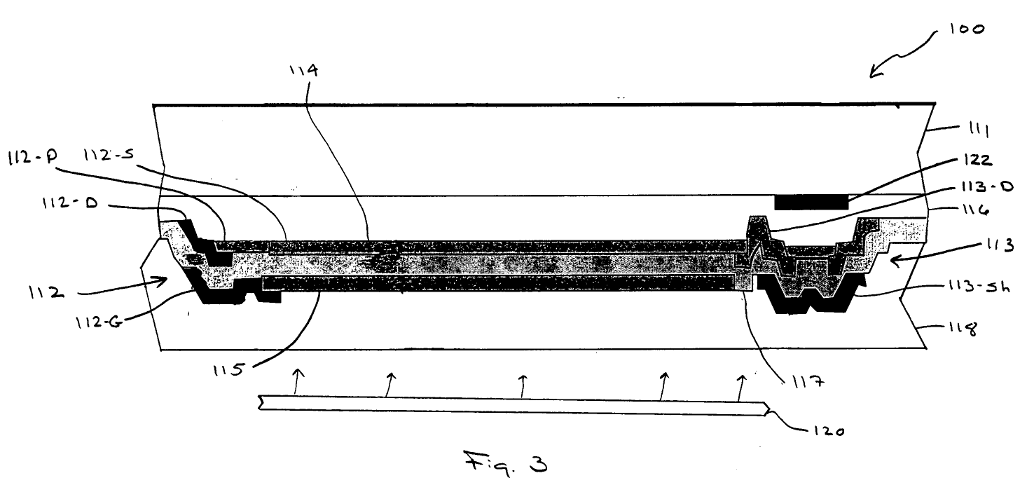

An image capture sensor in accordance with the present invention is shown in FIG. 3. Capture sensor 100 includes a passivation layer 118, which can be formed of SiNx. On top of passivation layer 118, a storage capacitor layer is formed including first electrode 115. This storage capacitor layer is preferably formed from indium tin oxide (ITO), which is conductive and transparent. On top first electrode 115, a insulating layer 117 is formed, preferably of SiNx. Over insulating layer 117, a second electrode 114 is formed, preferably of tin oxide. First electrode 115, insulating layer 117 and second electrode 114 together form the storage capacitor. Over second electrode 114, another insulating layer 116 is formed, which can be formed from SiNx. A layer of glass layer 111 is placed over insulating layer 116. A fingerprint to by imaged is placed on glass layer 111, which may be referred to herein as the imaging surface.

A light sensing unit 112, which is preferably a thin-film transistor, and a switching unit 113, which is also preferably a thin-film transistor, are horizontally arranged on a passivation layer 118. Under passivation layer 118, a back light 120 irradiates light upward to be passed through the fingerprint capture sensor 100. As shown in FIG. 3, back light 120 is separated from a lower, exposed surface of passivation layer 118. It is also considered, however, that backlight 120 be placed against lower surface of passivation layer 118. Backlight 120 can be an LED or any other type of light source as is understood in the art. A source electrode 112-S of the light sensing unit 112 and a drain electrode 113-D of the switching unit 113 are electrically connected through second electrode 114. A gate electrode 112-G of the light sensing unit 112 is connected to first electrode 115. Additionally, a first light shielding layer 113-sh is placed between insulating layer 117 and passivation layer 118 at switching unit 113. As detailed below, first light shielding layer 113-sh blocks light from backlight 120 from reaching swithing unit 113. Additionally, second light shielding layer 122 is positioned between glass layer 111 and insulating layer 116 at switching unit 113 to shield switching unit 113 from light passing through or reflected from glass layer 111.

In the above structure, a photosensitive layer 112-P such as amorphous silicon (a-Si:H) is formed between the drain electrode 112-D and source electrode 112-S of the light sensing unit 112. As is understood in the art, photosensitive layer 112-P allows current to flow in response to a predetermined amount of light striking a surface of photosensitive layer 112-P. In this way, when more than a predetermined quantity of light is received at a surface of photosensitive layer 112-P, current flows through the drain electrode 112-D and the source electrode 112-S.

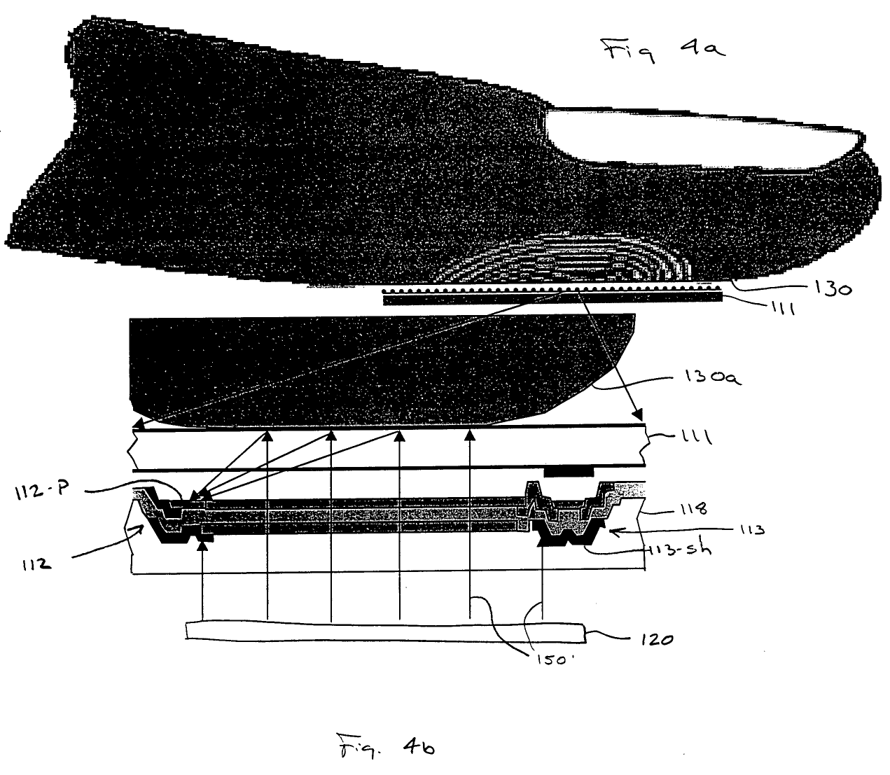

FIGS. 4a and 4b illustrate the operation of sensor 100 discussed above. FIG. 4a illustrates a fingerprint 130 placed against glass layer 111. FIG. 4b is a detailed view of a portion of FIG. 4a showing a single ridge of fingerprint 130a placed against glass layer 111 of sensor 100. Light 150, generated from back light 120 beneath passivation layer 118, is reflected from fingerprint ridge 130a and received by the photosensitive layer 112-P of the light sensing unit 112, thus causing electricity to flow in the light sensing unit 112. Gate electrode 112-G of light sensing unit 112 serves to block light 150 directly emitted by light source 120 from reaching light sensing unit 112 through a lower face thereof. Additionally, as discussed above, a portion of switching unit 113 from the drain electrode 113-D to the source electrode 113-S is covered with a light shielding layer 113-sh such that external light cannot be received by the switching unit 113.

When light photosensitive layer 112-P of light sensing unit 112 allows current to flow, the current passes through electrode 114 and into drain electrode 113-D of switching unit 113. This causes switching unit 113 to be activated, thereby indicating that a portion of a fingerprint ridge is above the location of sensor 100 in a fingerprint sensor array (not shown). If a fingerprint valley is above the location of sensor 100, then incident light from backlight 120 will be reflected back into sensor 100 to a far smaller degree than if a ridge is above the location of sensor 100. As such, photosensitive layer 112-P will not receive sufficient light to begin conducting sufficient current to activate switching unit 113. In this way, an array of image capture sensors such as image capture sensor 100 can be used to determine the contours of fingerprint ridges and valleys of a fingerprint placed on the imaging surface of such an array.

As discussed above, a glass surface, which is relatively durable, is used as the imaging surface for capture sensor 100. As such a relatively high degree of protection is provided to the rest of capture sensor 100. Also, the glass imaging surface can be relatively smooth, causing relatively little distortion in a captured image. Additionally, no extra coating over the surface of a capture sensor in accordance with the present invention is necessary.

Referring again to FIG. 3, in a method of fabricating capture sensor 100, a second light shielding layer 122 is first placed on glass layer 111 via evaporation, sputtering or any other method. Glass layer 111 is preferably between about 5 and 10 um, though may be either thicker or thinner. Light shielding layer 122 is preferably formed from a metal such as aluminum, but may be formed from any suitable light blocking material. Next, insulating layer 116 is formed on top of glass layer 111 and second light shielding layer 122. As noted above, insulating layer 116 is preferably formed from SiNx. Photosensitive layer 112-P is then formed over insulating layer 116. As discussed above, photosensitive layer 112-P is preferably formed from a-Si:H. Source electrode 112-D of light sensing unit 112, second electrode 114 and drain electrode 113-D of switching unit 113 are next formed over insulating layer 116. Source electrode 112-D, second electrode 114 and drain electrode 113-D are each preferably formed of ITO, but may be formed of any suitable conductor. Next, insulating layer 117 is formed and over insulating layer 117 first electrode 115 is formed. Insulating layer 117 is preferably formed from SiNx and first electrode 115 is preferably formed of ITO but may be formed of any suitable conductor. Next, gate electrode 112-G of light sensing unit 112 and light shield 113-sh are formed. Preferably, gate electrode 112-G and light shielding layer 113-sh are each formed of ITO, but may be formed of any suitable material and light shielding layer 113-sh does not need to be formed from the same material as gate electrode 112-G. Next, passivation layer 118, which is preferably formed from SiNx, is formed over first electrode 115, gate electrode 112-G and light shielding layer 113-sh. As discussed above, backlight 120 can either be attached to the lower, exposed surface of passivation layer 118 or separately supported in a known manner.

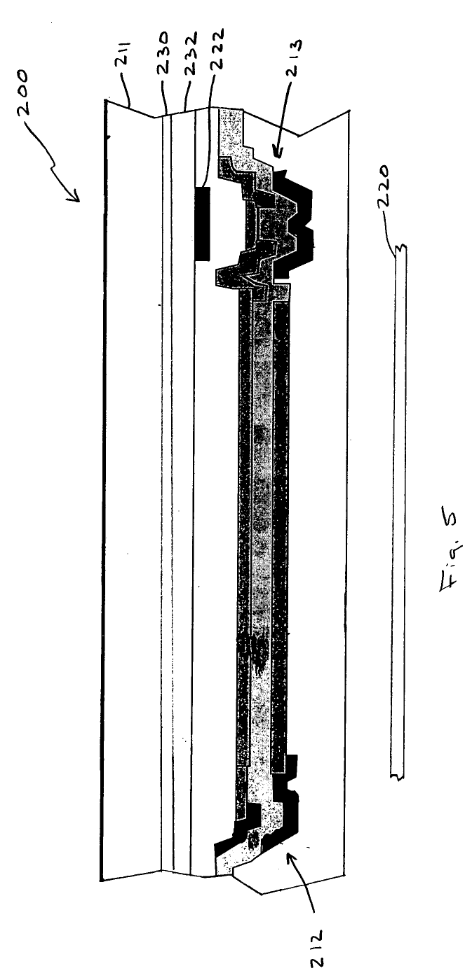

A second embodiment of an image capture sensor in accordance with the present invention is illustrated in FIG. 5. Image capture sensor 200 has substantially the same structure as capture sensor 100 except that conductive ITO layer 230 is placed beneath glass layer 211 and an insulating layer 232, which can be formed of SiNx, is placed below ITO layer 230. Because ITO layer 230 is conductive, electrostatic charge built up on glass layer 211 can be discharged by connecting ITO layer to a ground in a known manner. This can advantageously prevent damage to capture sensor 200. Image capture sensor can be fabricated in substantially the same manner as image capture sensor 100 except that ITO layer 230 is formed over glass layer 211 and insulating layer 232 is formed over ITO layer 230 prior to forming light shielding layer 222 over insulating layer 232.

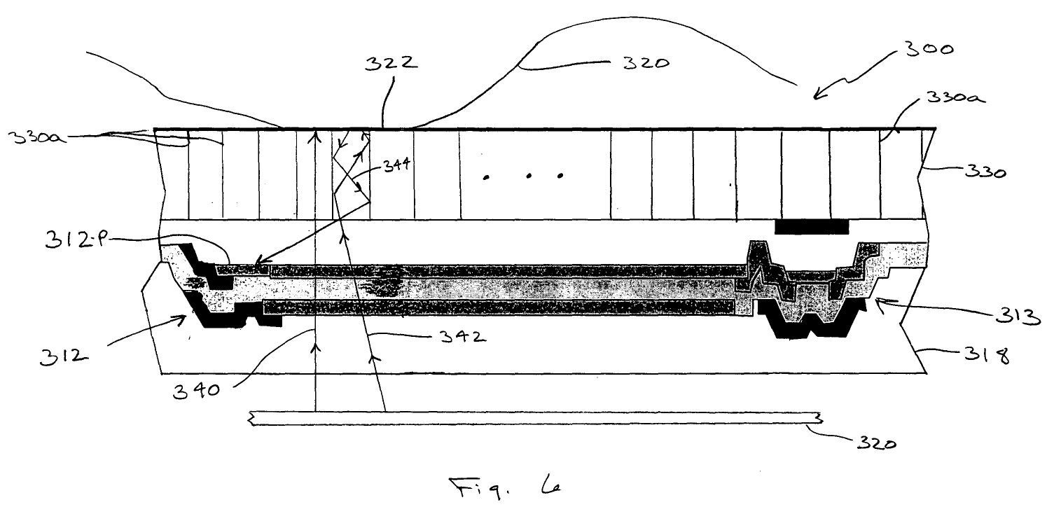

A third embodiment of an image capture sensor in accordance with the present invention is shown in FIG. 6. Image capture sensor 300 has substantially the same structure as capture sensor 100. Specifically, capture sensor 300 includes a light sensing unit 312, which is substantially the same and light sensing unit 112, and switching unit 313, which is substantially the same as switching unit 113, formed between an insulating layer 316 and a passivation layer 318. However, above insulating layer 316 capture sensor 300 includes a substrate layer 330 having a plurality of fiber-optic strands 330a running in a direction perpendicular to a surface of substrate layer 330. Preferably, the diameter of the fiber-optic strands 330a forming substrate layer 330 is from about 4 um to about 8 um in diameter and more preferably about 6 um in diameter, though larger or smaller diameters can also be used. Substrate layer 330 can be formed from glass fiber optic strands 330a or fiber optic strands of other substantially transparent materials including polymers. Fiber optic sheets which can be used to form substrate layer 330 are known in the art and available from, for example, Schott Fiber Optics of Southbridge Mass.

In operation, as shown in FIG. 6, a fingerprint 320 including a fingerprint ridge 322 to be imaged is placed on an exposed surface of fiber-optic layer 330. Incident light from backlight 320, which can be substantially the same as backlight 120 of capture sensor 100, passes into fiber-optic layer 330 and can either directly pass through fiber-optic layer 330 as shown by arrow 340, or pass through fiber-optic layer 330 by undergoing total internal reflection (TIR) from the sides of a fiber-optic strand 330a, as shown by arrow 342. In either case, if the incident light from backlight 320 strikes a fingerprint ridge 322, it will scatter back through fiber-optic layer 330 either directly or, as shown by arrow 344, undergoing TIR to reach photosensitive layer 312-P of light sensing unit 312. Because light scattered from a fingerprint ridge 322 can undergo total internal reflection to pass through fiber-optic layer 330, fiber-optic layer 330 can be relatively thicker than a glass layer such as glass layer 111 without degrading the performance of capture sensor 300. As such, fiber-optic layer is preferably 0.8 mm to 1.0 mm but may be either thicker or thinner. Because, as described above, fiber-optic layer can be relatively thick, a fiber-optic layer such as fiber-optic layer 330 can provide relatively more protection for an image capture sensor such as image capture sensor 300. Image capture sensor 300 can be fabricated in substantially the same manner as image capture sensor 100 except that fiber-optic layer 330 is used in place of glass layer 111. It is also considered that glass layer 211 of image capture sensor 200 be replaced by a fiber-optic layer such as fiber-optic layer 330.

Although particular embodiments have been described in detail, various modifications to the embodiments described herein may be made without departing from the spirit and scope of the present invention, thus, the invention is limited only by the appended claims.

1. An image capture sensor including:
a light detection transistor including a light sensitive layer which conducts electricity in response to detection of a predetermined amount of light;
a switch interconnected to the light detection transistor and responsive to detection of light by the light detection transistor;
a glass substrate layered over the light detection transistor and switch and upon which a patterned object to be imaged in placed.

2. The device of claim 1 further including a capacitor that interconnects the light detection transistor and the switch.

3. The device of claim 2 wherein the switch is a transistor switch.

4. The device of claim 3 including a first light shielding layer that reduces the amount of light to which a first surface of the light sensitive layer is exposed.

5. The device of claim 4 wherein the glass substrate includes a fiber-optic layer having fiber-optic strands formed perpendicularly to a surface of the fiber-optic layer on which an object to be imaged is placed.

6. The device of claim 5 wherein the object to be imaged is a fingerprint.

7. The device of claim 6 including a backlight positioned such that the light sensitive transistor and switch are positioned between the glass substrate and the backlight.

8. The device of claim 4 including a conductive layer and an insulating layer, the conductive layer formed over the glass substrate and the insulating layer formed over the conductive layer such that both the conductive layer and the insulating layer are between the glass substrate and the light sensing transistor.

9. The device of claim 7 wherein the object to be imaged is a fingerprint.

10. A method of imaging a patterned object including:
providing an image capture sensor having:
a light detection transistor including a light sensitive layer which conducts electricity in response to detection of a predetermined amount of light;
a switch interconnected to the light detection transistor and responsive to detection of light by the light detection transistor;
a glass substrate layered over the light detection transistor and switch; and
placing the object to be imaged on the glass substrate.

11. The method of claim 10 wherein placing the object to be imaged on the glass substrate includes placing a fingerprint to be imaged on the glass substrate.

12. The method of claim 11 wherein providing an image capture sensor includes providing an image capture sensor having a glass substrate including fiber-optic strands.

13. The method of claim 11 wherein providing an image capture sensor includes providing an image capture sensor having a conductive layer formed over the glass substrate and an insulating layer formed over the conductive layer.

14. An image capture sensor including:
a light detection transistor including a light sensitive layer which conducts electricity in response to detection of a predetermined amount of light;
a switch interconnected to the light detection transistor and responsive to detection of light by the light detection transistor;
a substrate layered over the light detection transistor and switch and upon which a patterned object to be imaged in placed, the substrate including fiber-optic strands.

15. The device of claim 14 further including a capacitor that interconnects the light detection transistor and the switch.

16. The device of claim 15 wherein the switch is a transistor switch.

17. The device of claim 16 including a first light shielding layer that reduces the amount of light to which a first surface of the light sensitive layer is exposed.

18. The device of claim 17 wherein the fiber-optic strands are formed perpendicularly to a surface of the substrate.

19. The device of claim 18 wherein the object to be imaged is a fingerprint.
